(19) United States
(12) Patent Application Publication
(10) Pub. No.: US 2012/0303834 A1
(43) Pub. Date: Nov. 29, 2012

(54) SEAMLESS DIGITAL STREAMING OVER DIFFERENT DEVICE TYPES

(75) Inventors: Tarek N. Adam, Manhasset, NY (US); Igg Adiwijaya, Manhasset, NY (US)

(73) Assignee: Stellatus, LLC, Manhasset, NY (US)

(21) Appl. No.: 13/481,761

(22) Filed: May 25, 2012

Related U.S. Application Data
(63) Continuation of application No. 13/269,078, filed on Oct. 7, 2011, now abandoned.
(60) Provisional application No. 61/390,849, filed on Oct. 7, 2010.

(51) Int. Cl. G06F 15/16

(52) U.S. Cl. 709/231

(57) ABSTRACT

The claimed invention provides a single generic solution by treating live video capture as any other running application on the end-user screen. This allows the technique of capturing consecutive snapshots of a running application window to be applicable to live video capture as well. Specifically, the invention captures and generates video streams for the different content types as follows: (1) live video. Unlike prior art approaches where the capturing software interacts directly with an on-board camera, the invention interacts with and streams the camera playback window; (2) Static video. Rather than streaming directly off the video file, the invention enables the video file to be played on the screen and the playback window to be captured and streamed; and (3) View of running application and view of user desktop. The invention takes consecutive snapshots of an application window or desktop, generates video out of the snapshots, and streams it.

### CROSS-REFERENCE TO RELATED APPLICATIONS

This application is a continuation of U.S. application Ser. No. 13/269,078, filed Oct. 7, 2011, which claims the priority of U.S. Provisional Application No. 61/390,849, filed Oct. 7, 2010, the entire contents of which are fully incorporated herein by reference.

### BACKGROUND OF THE INVENTION

Current video-telephony capability is limited to a handful of mobile devices and service providers with video-telephony applications typically relying on specific hardware and OS/software of the mobile phones. Video and audio transmissions are delivered on the same channel and require high level of transmission bandwidth. As a result and due to the service provider's limited network bandwidth (such as 2G or 3G), the quality of the video is low and the cost for the customers is high. Often the video stream only works in one direction. As a result the receiving party is restricted to only viewing, rather than both the initiating as well as the receiving parties being able to each transmit video and view incoming video stream at the same time.

When an end-user, in the middle of viewing online multimedia content on a viewing device such as a desktop PC, needs to switch to a different device, such as cell phone, he/she cannot easily resume viewing the content from the point he/she left. Current content distribution systems require the end-user to re-register the new device, reload the content to the new device, and start viewing from the beginning of the content rather than from where he/she left off.

For local multimedia content such as movies and CD/DVDs, before an end-user can use a different viewing device to view the local content, he/she has to replicate the same content onto the new viewing device and reload the content from the beginning. The process of copying and reloading is cumbersome and time-consuming.

Different viewing devices play only certain media formats, such as AVI, MPEG, FLV and MP4. An online Flash-formatted movie does not play without Flash player software pre-installed, and a local DVD movie playing on a desktop PC is not readily playable on a cell phone. Currently, the end-user needs to deal with format conversion in order to switch from one viewing device to another, resulting in a disjointed and unsatisfying viewing experience. Having to switch between solutions is cumbersome, time-consuming, and results in an unsatisfying user experience. Furthermore, depending on the type of devices, not all capabilities, such as sharing a view of running videos on a phone screen with others, or seamless switching between live capture and sharing running windows, are supported.

Thus, it would be desirable to have a system capable of handling these various aspects in a manner that is simple to use and is transparent to the end-user.

### SUMMARY OF THE INVENTION

Rather than having a different solution to handle each of the different types of content, the claimed invention provides a single generic solution by treating live video capture as any other running application on the end-user screen. This allows the technique of capturing consecutive snapshots of a running application window to be applicable to live video capture as well. Specifically, the invention captures and generates video streams for the different content types as follows.
Live video. Unlike prior art approaches where the capturing software interacts directly with an on-board camera, the invention interacts with and streams the camera playback window.
Static video. Rather than streaming directly off the video file, the invention enables the video file to be played on the screen and the playback window to be captured and streamed.
View of running application and view of user desktop. The invention takes consecutive snapshots of an application window or desktop, generates video out of the snapshots, and streams it.

In addition to being able to stream content beyond live video capture, the claimed invention allows streaming of different content types in a single session. As used herein, a “session” is a unique stream transmission out of an end-user device. An end user can capture and stream live video one minute and stream a different content type, i.e., a view of a running presentation document, the next minute, in a single transmission. There is no need to terminate a running streaming session and open a new one. An end user can simply toggle between running application windows to stream different content types. On the viewer's viewing device, it all appears as a single seamless video stream.

The claimed invention also enables identification of all available network connections and streams using the best-available connection. This capability is beneficial for improving quality of video streams and reducing network congestion. For video-telephony, the invention leverages traditional telephony for the audio portion of a video-telephone transmission, while including only images (i.e., all audio excluded) within the video stream. It uses the best network connection available for streaming the individual portions of the video-telephone transmission. For example, while the audio portion of the video-telephony session is carried by a service provider network such as 2G or 3G, the video portion can be streamed over a WiFi connection.

Although the above discussion is focused on desktop PC and cell phone applications of the invention, it is understood that the invention has applicability with other types of devices including televisions and game consoles. This is accomplished by configuring the devices using, e.g., client software that configures the devices to perform the operations of the invention.

### BRIEF DESCRIPTION OF THE DRAWINGS

FIG. 1 is a block diagram illustrating an overview of a system of the present invention;

FIG. 2 depicts the workflow for a social networking application;

FIG. 3 depicts a more detailed flow diagram for the workflow of FIG. 2;

FIG. 4 provides more detail on the flow taking place at the end user's device side—the Streaming Client and Viewing Client;

FIG. 5 describes the process of streaming from a PC device which starts with the end user activating the client application and selecting the streaming feature;

FIG. 6 is a detail flow diagram for a Viewing Client—mobile-phone;

FIG. 7 is a detail flow diagram for a Viewing client—PC;

FIG. 8 is a block diagram illustrating a general system architecture for streaming video in accordance with an embodiment of the claimed invention;

FIG. 9 depicts a more detailed flow diagram for a Video Telephony application;

FIG. 10 is a detailed flow diagram for a Streaming client—mobile-phone caller;

FIG. 11 is a detailed flow diagram for a Streaming Client—PC caller;

FIG. 12 is a detailed flow diagram for Viewing client—mobile-phone viewer;

FIG. 13 is a detailed flow diagram for a Viewing Client—PC receiver; and

FIG. 14 is a flow diagram illustrating portions of the work flow for the Streaming Client side.

### DETAILED DESCRIPTION

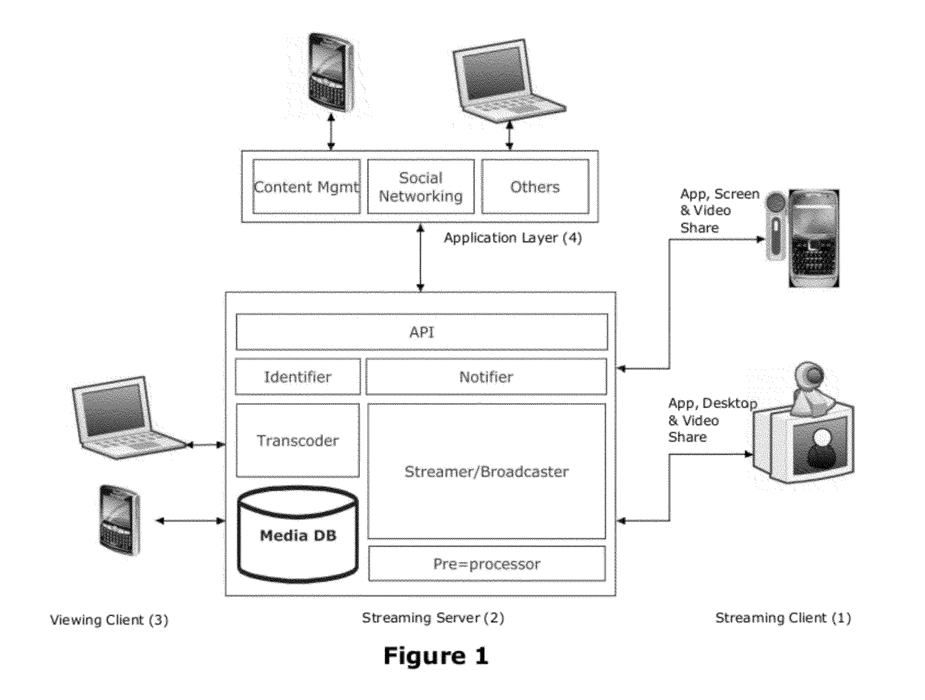

FIG. 1 is a block diagram illustrating and overview of a system of the present invention. As depicted in FIG. 1, the approach consists of 4 main components: 1) streaming client; 2) streaming server; 3) viewing client; and 4) application layer. Beyond traditional live video capture, this approach handles different types of content. These types can be grouped as follows:
1. Live video, which is defined herein as a live event captured by camera-equipped devices such as camera-ready cell phones or webcam-equipped PCs.
2. Static video, which is defined herein as video content created some time in the past and stored in a digital form, such as movie files stored in local disks, CD/DVD, databases and Internet.
3. Running application, which is defined herein as snapshot images of a running application window. On a PC desktop, any of the active windows can be a target snapshot. On a cell phone screen, the active application is the target view, typically covering the entire screen. Consecutive snapshots of application windows can be taken, along with any running audio, to generate video stream. Audio can be optionally excluded from the video stream.
4. View of user desktop, which is defined herein as snapshot images of the user PC desktop or phone screen.

For simplicity, each of these types of content is referred to generically herein as “video”.

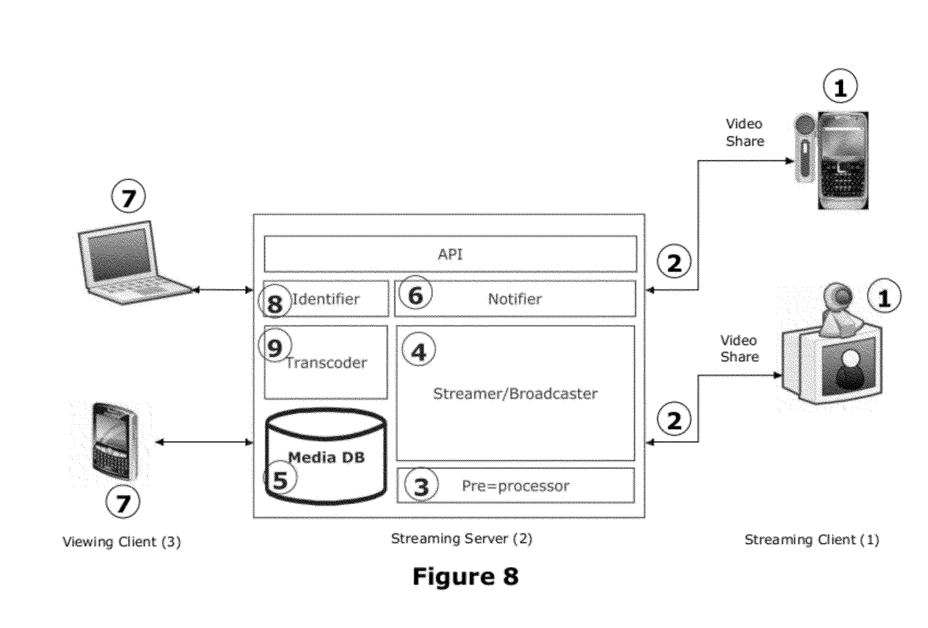

The streaming client illustrated in FIG. 1 comprises devices and client software that initiate and stream videos. In a preferred embodiment, this functionality is provided by utilizing software that configures the devices to perform the various steps of the present invention, as described further herein in connections with FIGS. 1-14.

(i) 3.1.2. Streaming Server

The streaming server 2 illustrated in FIG. 1 includes a backend system which handles, stores and broadcasts video streams. It manages user information, notification, access rights and format conversion. It includes several sub-components, including a pre-processor, streamer/broadcaster, notifier, media database, identifier, and transcoder. The pre-processor component accepts and processes streaming and broadcasting requests from end-user devices. The streamer/broadcaster component makes up the largest part of the streaming server. It manages broadcasts and delivers streaming video to end-user devices. The notifier component notifies end-users of outstanding video streams or incoming conversion. Notification can be delivered via several means including email, text-message, online messenger, or client application alert. The media database component stores and maintains archived videos, user and group profile, and other needed information. The identifier component is responsible for identifying the characteristics and capabilities of the viewing client devices such as device type, operating system, screen size, browser application and version. The identifier component is also responsible for determining the best media format to deliver, given the characteristics and capabilities of a given viewing device. The transcoder component converts one video format to another such as from MPEG format to MOV format.

Prior to receiving any video stream, the streaming server 2 receives streaming specification and handling requirements related to the incoming video originating from the streaming client devices 1. This information, referred to as streaming metadata, includes end-user request information—such as user profile, saving options and target viewers—and stream characteristics such as content type, video/audio quality, viewing access and notification parameters. Streaming metadata and associated incoming video streams are handled by the pre-processor component of streaming server 2.

Depending on what is included in this streaming metadata, the pre-processor can initiate a range of actions. For example, if an incoming video stream is intended for storage purposes only, as in the case of a content management application, an action to save the stream until it terminates would be initiated, with broadcasting of the video stream occurring only at the completion of the saving process. Any required transcoding request would be done upon demand by the viewers or video owners.

If, however, the incoming video stream is intended for, e.g., a social networking service accessible by public or groups, the streamer/broadcaster component is initiated to broadcast the incoming stream and saves the stream into storage (i.e., media database) at the same time. The transcoder component converts the incoming stream into a single video format, such as Flash, in real time. Since the broadcast is viewed on demand, there is no need for any push notification from the notifier component.

If the incoming stream is intended for immediate consumption only by an authorized viewer, such as in video-telephony service, the notifier component sends a push alert to the specified viewer via the client software of the invention, email, online messenger or phone text-messaging. For a viewer with a user account authorized by the system, his/her user account is tagged for alert. The next time the viewer runs the client software of the invention on his/her viewing device, he/she will be immediately alerted of an incoming video stream. Optionally the incoming video stream can be automatically played on the viewer's viewing device. For email, online messenger and text-messaging notification, a link to location of the incoming video stream is provided. Once the end-user on the receiving end (the viewer) clicks on the link, the viewing device web browser is activated and the link location is accessed for playback on the browser. Requests from the viewer's web browser are intercepted by the identifier component. The identifier component automatically detects the viewer's device characteristics and capabilities such as hardware, OS, browser, version and media player. Depending on this information, the transcoder component converts the incoming video stream into a format playable on the viewer's viewing device. For example, for a desktop PC with Flash player, the transcoder converts incoming video streams into FLV or SWF formatted streams. A viewer with an iPhone would view the incoming video stream in MP4 or MOV format.

The Application Programming Interface (API) component provides a standard interface for the application layer and third-party system to interact with the streaming server component, leveraging its functionalities, and access stored videos.

(ii) 3.1.3. Viewing Client

The viewing client comprises devices and, optionally, is configured with the client software of the invention for viewing video streams broadcast from the streaming server. To view any video stream, there is no requirement that the client software of the invention be pre-installed on the viewing device. Instead, the viewer may use any common web browser to do so. As described previously, the identifier and transcoder components of the streaming server of the invention are capable of detecting the characteristics of the viewing device and consequently stream the video in a format playable on that viewing device.

Although FIG. 1 shows two types of devices—a desktop PC and a cell phone—it is contemplated and understood that the transcoding capability of the invention is capable of automatically handling other types of device including TV and game consoles.

(iii) 3.1.4. Application Layer

The application layer 4 acts as a container to separate application-specific features from the generic streaming server component. This layer leverages capabilities of the streaming server via the API component and can be extended without any changes to other components.

The content management system of the application layer 4 provides end users or content providers with the ability to upload and store live video captures or static video files, regardless of media formats. It enables end-users to convert video from one format into another. For content providers, the content management system can be used as an additional repository for multimedia content, as well as an extension of their online websites. The system of the invention also allows end-users of social networking applications to broadcast live video captures from desktop PCs or cell phones for viewing by the public or by groups. End users and viewers may capture, broadcast and view live video captures in real-time, as well as communicate via chat interfaces at the same time.

### Overall Architecture

Examples of 3 main applications (social networking, video telephony and content sharing) that the architecture supports are described below.

2. Social Networking

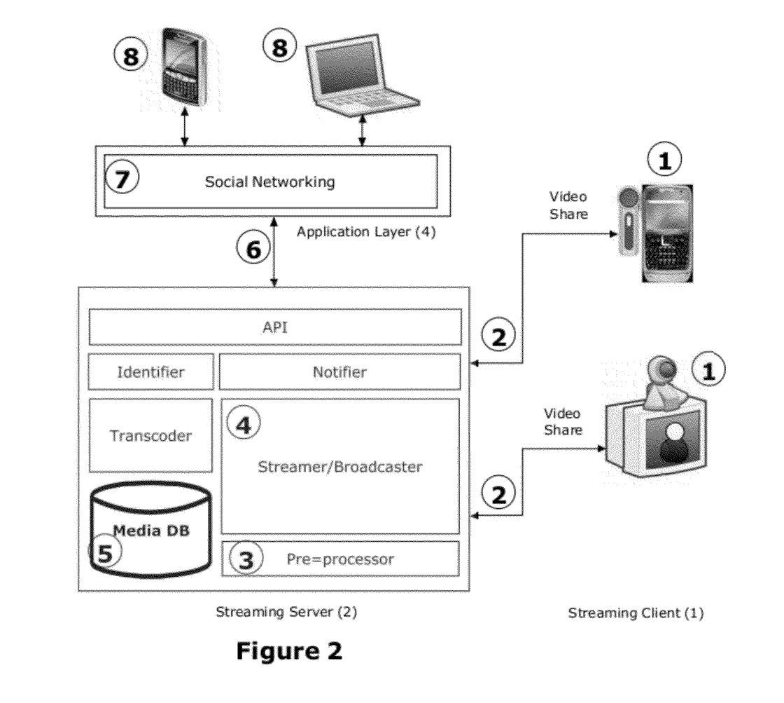

The workflow for social networking application is depicted in FIG. 2.

The workflow for FIG. 2 is as follows.
1. The social networking application starts with an end-user (Streaming Client) capturing live video using a mobile phone or webcam-equipped PC.
2. A streaming metadata, consisting of end-user streaming specifications, such as resolution, size, audio, archive option, title, author info, target audience, permission and others, is first sent to the Streaming Server. Upon confirmation from the server, the mobile phone or PC starts streaming the video.
3. The Pre-processor component interacts with the end-user ‘streaming’ device. Based on the streaming metadata, it performs certain set of actions, such as preparing for live broadcast or archiving incoming stream.
4. Incoming stream is prepared and ready for broadcasting by the Broadcaster component.
5. If the streaming metadata include request for archiving the incoming stream, it is archived and stored within the Media database. If the request is for archival only, incoming stream is not available for viewing until after archiving is completed.
6. Upon completion of archiving process and/or broadcast preparation, metadata and processing status are forwarded to the Application Layer (i.e., Social Networking application layer) for registration and application-specific processing.
7. The Application Layer performs set of actions, such as cataloging, setting access, updating user page, alerting and others. At this point, the process terminates and the Application Layer waits for any viewing request.
8. Viewing live or static video starts with end-user (Viewing Client) receiving notification or visiting the Social Networking application portal, where he/she can browse and search for videos. Once a video is requested, the Social Networking application layer processes the request and redirects to location of the video at the Streaming Server.

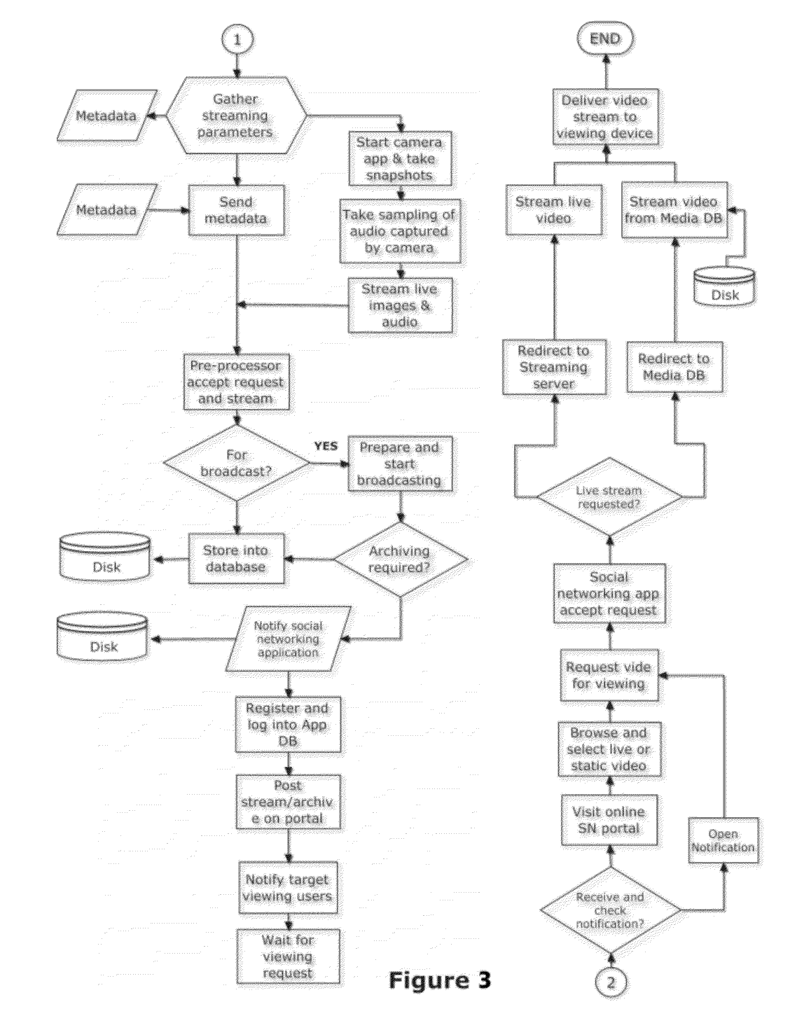

FIG. 3 depicts a more detailed flow diagram for the workflow of FIG. 2. The left diagram depicts the first half of the Social Networking application flow—initiation of video stream. The right diagram represents the flow for requesting and viewing video stream. The blocks are grouped into end user layers representing the end user side, i.e., Streaming Client and Viewing Client; Streaming Server layers; and Application layers.

(1) Streaming Video Flow:
The flow starts with the end user (Streaming Client) starting the phone client application. The client app gathers all necessary streaming parameters, such as image size, transfer rate, video format, audio option and archiving option, and stores as streaming metadata. At this time end-user may specify his/her own values or use default settings.
Once all streaming metadata are gathered, the client application starts two processes at the same time, sending streaming metadata to the Streaming Server and interacting with client device on-board camera application.
It starts the camera application and takes snapshots of the camera application view.
It also captures any running or captured audio.
It streams out these snapshot images and audio as a video stream to the Streaming Server.
At the Streaming Server side, the Pre-processor first receives the streaming metadata from the streaming device.
It checks the metadata if the incoming stream is intended for live broadcast or archival only.
In the case of archival only, it stores the incoming stream as a video file in a local database or disk. No access to the incoming stream and video file is allowed until after completion of archiving process.
Once the archiving process is completed, the Streaming Server sends notification to the Social Networking application that a new video is added and forwards metadata and status information, such as video file, location, length, date and others.
If the incoming stream is for broadcasting, a broadcast channel/port and configuration are prepared.
If archiving is also requested, the same archiving process as in the previous is performed while performing live broadcast at the same time.
Once the live broadcast channel is configured, the Streaming Server sends a notification to the Social Networking application and forwards metadata and broadcasting status information.
When receiving notification, the Social Networking application registers the new video as new entry into the database.
The new video is posted and published on the portal site.
If specific audiences or groups are specified, they are notified (via SMS, email or messenger) and their accounts are tagged.
Lastly, the Social Networking application waits for any video request from end-users (Viewing Client). At this point the process ends.

(2) Viewing Video Flow:
The flow for viewing video starts with end user (Viewing Client) visiting the Social Networking application portal and/or receiving notification of new video.
When visiting the application portal, the viewing user can browse and search for videos.
When opening the notification, the viewing user sees a message and direct link for requesting the associated video. Clicking on the link sends the request for video to the Social Networking application.
Upon receiving the video request, the Social Networking application determines if it is for live video stream or archived video.
If it is for live streaming video, the request is directed to the Streaming Server where the streaming video is already broadcasting.
If the request is for archived video, the request is directed to the Streaming Server, which in turn accesses local Media database or disk where the video is stored.
Once located, the video is streamed to the end-user's viewing device and video playback starts on the viewing device. At this point the process ends.

One novel aspect of the present invention is that, while existing broadcasting technologies require end users to visit some pre-defined site for viewing video stream, the claimed invention is capable of actively pushing video stream onto end users' viewing devices via the notification mechanism.

### 2.2. Streaming Client

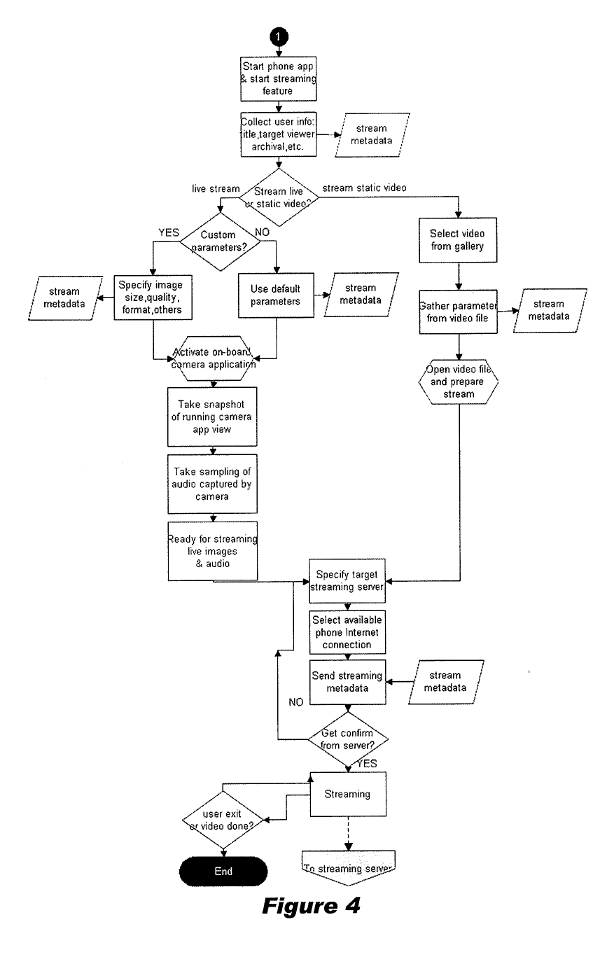

FIG. 4 provides more detail on the flow taking place at the end user's device side—the Streaming Client and Viewing Client. This example covers primarily mobile-phone and PC device types. The Streaming Client is discussed in this section, followed by discussion of the Viewing Client in the next section.

(i) 2.2.1. Mobile Phone Client
The process of streaming from a mobile phone device starts with the end user activating the client application and selecting the streaming feature.
The client application asks the end user to supply the title of the streaming, target viewers, archival option, and other related information. This comprises part of the streaming metadata.
The end user specifies if the stream is coming from live video capture or from existing local video file stored on the phone.
For a local video file, the end user browses and selects the video file from a mobile phone video gallery.
Once a video file is selected, video file basic information, such as name and format, is gathered and stored as part of the streaming metadata.
Next, the client application prepares the selected video file for streaming.
For live streaming, the end user supplies additional information such as image size, quality, format and others, or uses some default parameters.
The client application activates the phone's onboard-camera application.
Once the camera application runs, the client application starts taking snapshots of the view and sampling from any running audio.
The snapshot images and audio sampling comprise the streaming video. It is prepared for streaming.
Once video streaming is ready, the target Streaming Server is specified.
The Client application detects and selects any available Internet connection.
Once an Internet connection is established, streaming metadata is sent to the Streaming Server and waits for confirmation.
If there is no confirmation from the server, the end user needs to re-supply or correct their entry for the target Streaming Server and Internet connection before resending the metadata again.
Upon successful confirmation, the client application streams the video to the Streaming Server until the end of the video is reached or the end user exits. At this point, the process ends.

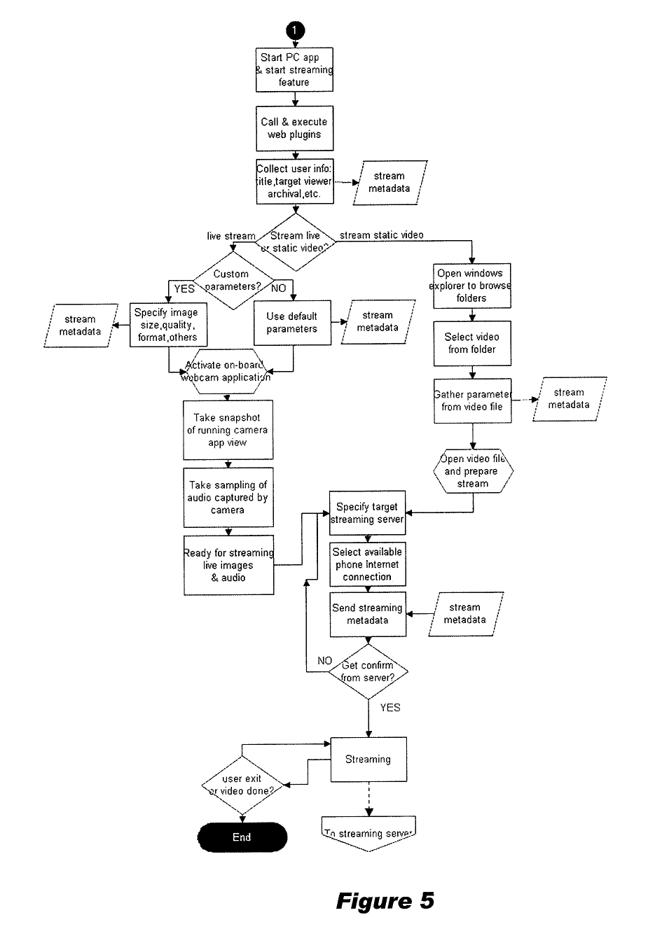

(ii) 2.2.2. PC Client
Referring to FIG. 5, the process of streaming from a PC device starts with the end user activating the client application and selecting the streaming feature. A client application for the PC is a thin application, with many of the features being retrieved from the online server on demand.
Once activated, the streaming feature is delivered via online plug-ins. These plug-ins functions as extensions to the client application.
Plug-ins collect user information, such as the streaming title, target viewers, archival and other information. This will be part of the streaming metadata.
The rest of the process is very much similar to the previous flow for mobile phone devices. The small difference is on the interaction with PC webcam, instead of on-board camera for mobile phone.

### (b) 2.3. Viewing Client

In this section, more detail is provided on the flow taking place at the Viewing Client side.

(i) 2.3.1. Mobile Phone Client

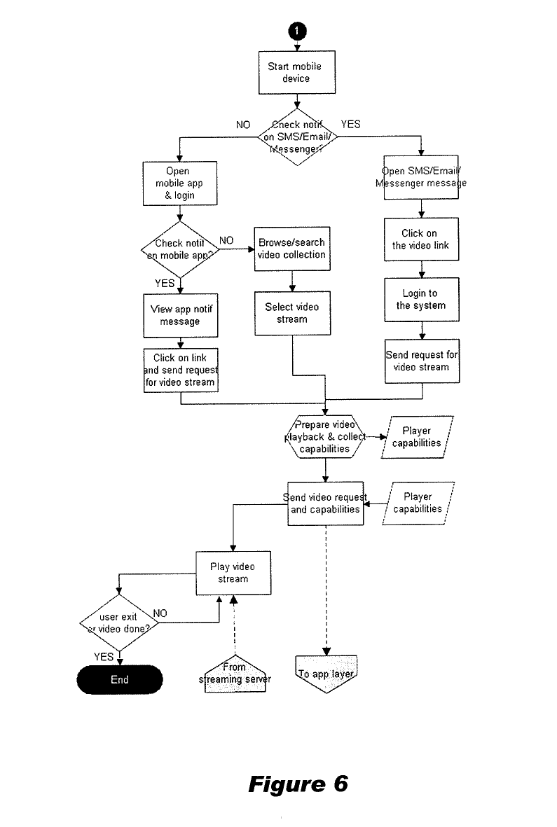

FIG. 6 is a detail flow diagram for a Viewing Client—mobile-phone
Referring to FIG. 6, the process of viewing video on a mobile phone starts with the viewing end-user activating the client application or receiving notification via SMS, email or messenger.
Opting to check for notification, the viewing user opens a corresponding SMS, email or messenger application.
The notification consists of a message and link to the associated video.
When clicking on the link, the client application is activated. The viewing user is required to login. In the case of a missing client application, clicking on the link leads to opening the web-browser.
Once access is granted, a request for the video stream is sent.
If the viewing end-user opts to open the client application instead, the client application is activated and the viewing user is required to login.
Notification may also be delivered via the client application. Any notification is highlighted when the user logins.
If the notification is viewed and a direct link to the associated video is clicked, a request for the video stream is prepared.
If the viewing user opts to ignore the notification, he can browse/search the video collection.
Once a video stream is selected, the video playback is prepared. Playback capabilities, such as player, format, OS and other, are collected.
The Client application redirects the video request and sends playback capabilities to the Application layer (i.e., Social Networking application).
The Application layer processes the request and redirects it to the Streaming Server. In turn the Streaming Server transmits the video stream to the end user viewing device.
Upon receiving the incoming video stream, the player on the mobile phone is activated and video is played-back.
The playing of the incoming video stream continues until the stream terminates or the end-user exits. At this point the process ends.

(ii) 2.3.2. PC Client

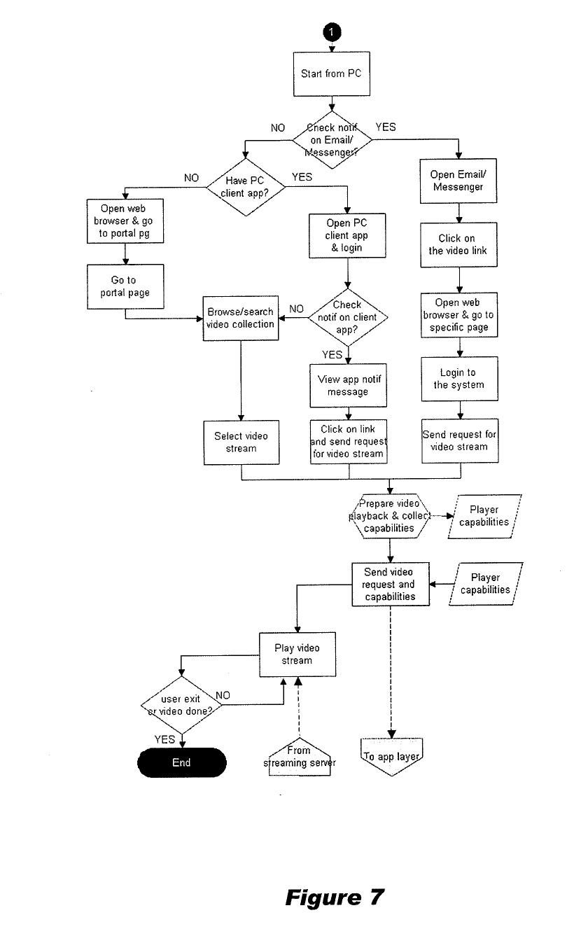

FIG. 7 is a detail flow diagram for a Viewing Client—PC

The detail process for viewing a video stream on a PC client (shown in FIG. 7) is very similar to the process for viewing a video stream on a mobile-phone client described in the previous section. Differences include:
There is no SMS notification for the PC client.
Instead of a built-in interface for browsing/searching and selecting videos within a mobile phone client, the PC client leverages the web-browser to do so. As mentioned earlier, the client application for PC device is a thin app, leveraging existing applications, such as a web-browser, to do some of the tasks.

3. Video Telephony

An example of the workflow for a video telephony application is depicted in FIG. 7. Referring to FIG. 7:
1. The video telephony application process starts with an end user (Streaming Client) making a telephone call using a mobile phone or PC.
2. For video telephony, the client application makes use of existing audio telephony. The streaming device transmits video without any audio to the Streaming Server. This is described in more detail herein. The client application also sends streaming metadata.
3. The Pre-processor component accepts and processes the streaming metadata and identifies the incoming video stream as a video telephony stream.
4. The pre-processor prepares and sets the incoming stream for ‘restricted’ broadcasting, i.e., only the target viewer has access to view.
5. If the archive option is also requested, the incoming stream will be archived in the Media database.
6. The Target viewer is notified by tagging his/her account in the system (if existing) or sending SMS/email/messenger messages. The streaming initiation process ends here, waiting for viewing request from authorized viewer.
7. Viewing of the streaming video starts with the viewing user (Viewing Client) receiving an audio phone call and notification via SMS, email or messenger from the Streaming Server at the same time.
8. While accepting the audio phone call, the viewing user opens the notification and clicks on the provided link, leading to sending a video request to Streaming Server. The Identifier component accepts this request, identifies the viewing user device characteristics, such as hardware, OS, web browser and media player, and determines the media format playable at the viewing user device.
9. The Transcoder component converts the incoming stream to a playable media format determined by the Identifier component and delivers the converted stream to the viewing user device.

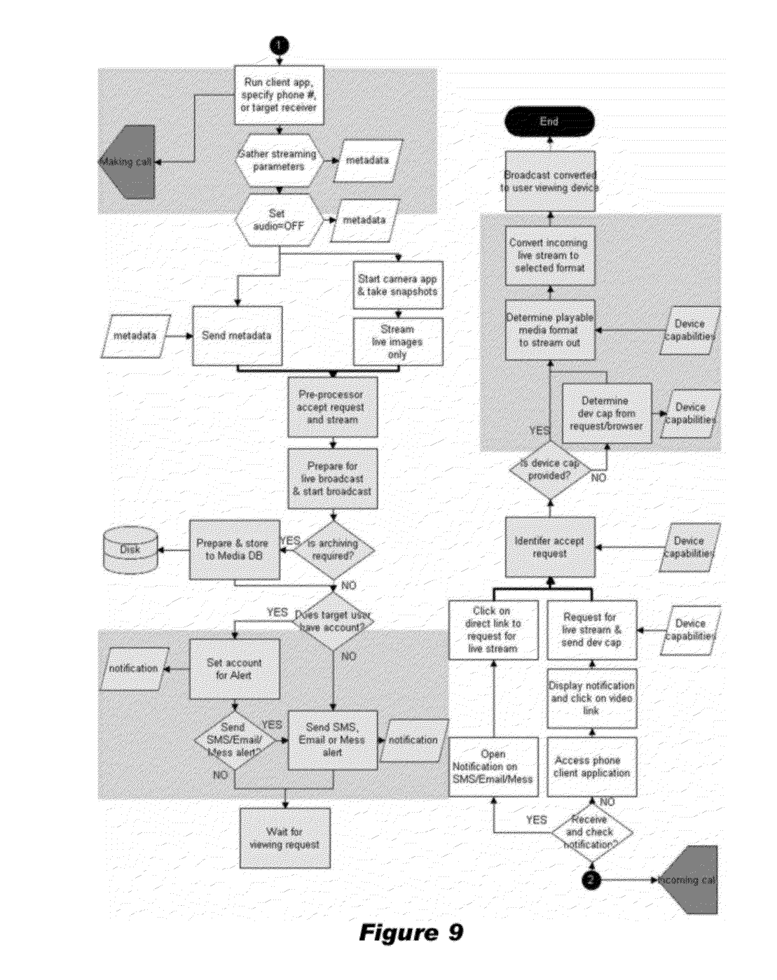

FIG. 9 depicts a more detailed flow diagram for a Video Telephony application. The left diagram depicts the first half of the flow—call initiation or caller. The right diagram represents the flow for receiving and playing video call. Similar to the previous application earlier, blocks are grouped by end user layers, i.e., Streaming Client and Viewing Client; Streaming Server layers; and traditional audio telephony.

(1) Caller Video Flow:
The flow starts with the end user or caller starting the client application and specifying the phone number of the target receiver. Alternatively, the caller may select the target receiver from a list of contacts from the client application.
Once the call is executed, the client application generates a new process that makes a call using the existing audio telephony channel.
The original process continues preparing for the video stream by gathering all necessary streaming parameters, such as image size, transfer rate, video format, audio option, archiving option, and others, and stores them as part of the streaming metadata. The caller may use default settings or specify different parameter values.
The client application sets the audio option to off. Only images are streamed out. This leverages the existing audio telephony channel.
Once all streaming parameters are gathered, the client application starts two processes at the same time. It sends streaming metadata to the Streaming Server and starts an onboard-camera application.
The Client application takes snapshots of the camera application view, once the camera runs.
It streams out only snapshot images as a video stream to the Streaming Server.
At the Streaming Server, the Pre-processor receives the streaming metadata from the caller.
Broadcasting channel/port and configuration are prepared and the incoming stream is forwarded for broadcast.
If archiving is also requested, it stores the incoming video stream into local database or disk.
The Streaming Server checks to see if the target receiver has an account in the system for notification.
If the receiver does not have any account, notification is delivered via SMS, email or messenger. The notification includes a direct link to the active video stream.
If the receiver does have an account, his/her account is flagged for alert. The next time the receiver accesses the system, he/she will be notified of an active video stream. It also checks to see if additional notifications need to be sent via SMS, email or messenger.
Once this is completed, the Streaming Server waits for the receiver's request for the video stream. At this point the caller process ends.

(2) Receiver Video Flow:
The video-telephony playback starts with the viewing end-user (Viewing Client) or receiver accepting the phone call and notification via SMS, email or messenger.
While still on the audio phone call, the receiver checks notifications on SMS, email or messenger or goes directly to the Streaming Server via the client application.
The Receiver may click on the web-URL link for the live video stream.
Clicking on the link opens the web-browser and sends the video request to the Streaming Server.
If the client application is activated instead, the receiver needs to login.
Once logged-in, any notification and direct link to the live video stream is presented to the receiver.
Clicking on the direct link sends a video request and the device capabilities to the Streaming Server. Device capabilities, such as media player, playable format and OS, are collected and stored locally by the client application.
Upon receiving the request for video, the Identifier component at the Streaming Server checks to see if the device capabilities are sent along with the request.
If they are not, it assumes that the request is coming from a common web-browser, instead of the client application. Background information, such as version and format, embedded within the web-browser request is processed. The Identifier determines the necessary device capabilities.
The Identifier component analyzes the capabilities to determine the format that is playable on the receiver viewing device.
The Streaming Server converts the incoming video stream into the playable format in real-time.
The converted stream is broadcast to the receiver viewing device.
Once the receiver views the stream, the process stops.

Novel aspects of the present invention include (but are not limited to):

Bi-directional video streaming allows end users to broadcast video streams and view an incoming stream at the same time.

The invention's separation of the audio from the images/video for video-telephony provides high quality audio, higher video quality and reduced cost to end-users.

The invention's capability to automatically identify viewing device's characteristics and deliver video stream in format playable on the viewing device removes the requirements for specific hardware and software on the viewing device.

The invention enables a seamless continuous user experience without the need to register new viewing devices and reloading/copying the same content.

### 3.2. Caller Device

In this section, more detail is given regarding the flow taking place at the caller device side (Streaming Client), mobile-phone and PC client.

(i) 3.2.1. Mobile Phone Client

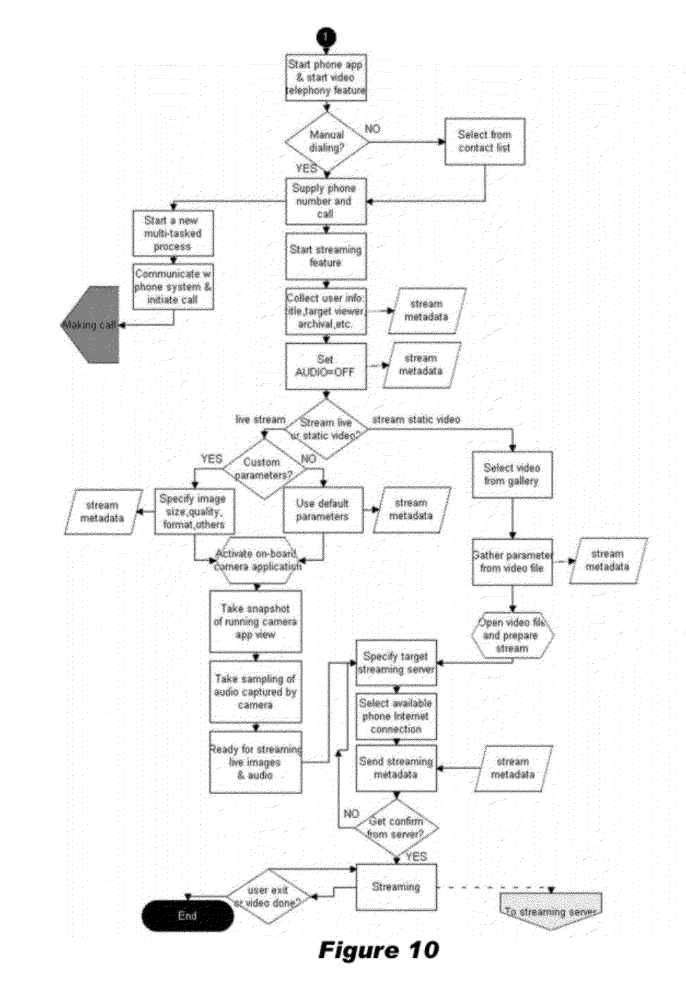

FIG. 10 is a detailed flow diagram for a Streaming Client—mobile-phone caller. Referring to FIG. 10:
The process of initiating video telephony on a mobile phone device starts with the caller activating the client application and selecting the video-telephony feature.
Within the feature, the caller may supply the receiver phone number manually or select from a list of contacts provided by the client application.
Once the phone number is provided and a call is activated, the client application creates a new process.
The new process communicates with the traditional audio telephony channel, supplies the phone number and initiates the audio call. The audio call continues running until canceled or the conversation terminates.
The Client application continues the original process and prepares for streaming live video capture.
It collects user information, such as streaming title, target viewers and archival options. This information is part of the streaming metadata.
It sets the audio option OFF. Only images are captured and streamed out. This is the case since audio is delivered by the traditional audio telephony channel.
The remainder of the process flow is similar to the detail sub-flow for social-networking streaming mobile-phone client described herein. For ease of understanding the flow, the sub-flow is repeated below.
The Caller specifies if the stream is coming from live video capture or from existing local video files stored on the phone.
For local video files, the caller browses and selects the video file from the video gallery.
Once a video file is selected, video file basic information, such as name and format is gathered and stored as part of streaming metadata.
Next, the client application prepares the selected video file for streaming.
For live streaming, the caller supplies additional information such as image size, quality, format and others, or uses some default parameters.
The client application activates the phone onboard-camera application.
Once the camera application runs, the client application starts taking snapshots of the view.
The snapshot images comprise the streaming video. It is prepared for streaming.
Once video streaming is ready, the target Streaming Server is specified.
The Client application detects and selects any available Internet connection.
Once an Internet connection is established, streaming metadata is sent to the Streaming Server and waits for confirmation.
If there is no confirmation from the server, the end user needs to re-supply or correct their entry for the target Streaming Server and Internet connection before resending the metadata again.

Upon successful confirmation, the client application streams the video to the Streaming Server until the end of the video is reached or the end user exits. At this point, the process ends.

(ii) 3.2.2. PC client

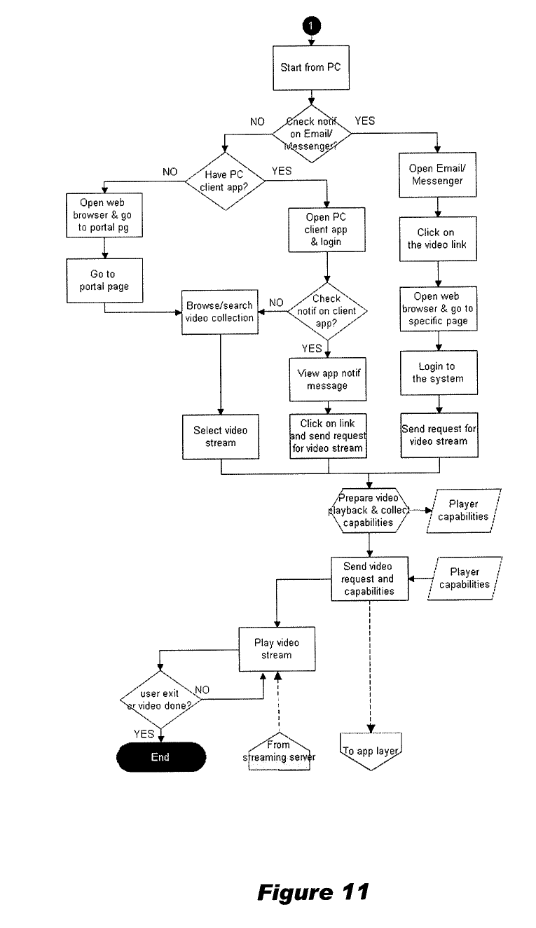

FIG. 11 is a detailed flow diagram for a Streaming Client—PC caller. Referring to FIG. 11:
The process of initiating video-telephony from PC device starts with the caller activating the client application and selecting the video-telephony feature within the application.
The Caller may manually specify the target receiver's phone number or select from the contact list.
Once the phone number is provided and the call is made, the client application generates a new parallel process which communicates with the existing audio-telephony system, such as Skype, and makes the call.
The client application continues with the original process. It downloads and executes web plug-ins for video-telephony. The web-plug-ins function as extension to the client application.
The plug-ins collect user information, such as the streaming title, target viewers, archival information and others. This will be part of the streaming metadata.
The rest of the process is very much similar to the previous flow for mobile phone devices. The difference is the interaction with and use of a PC webcam for live video capture, instead of the on-board camera for the mobile phone; and browsing local folders for static video files, instead of a video gallery for the mobile phone.

### (b) 3.3. Receiver Device

In this section, more detail is provided on the flow taking place at the receiver device (Viewing Client). (i) 3.3.1. Mobile Phone Client

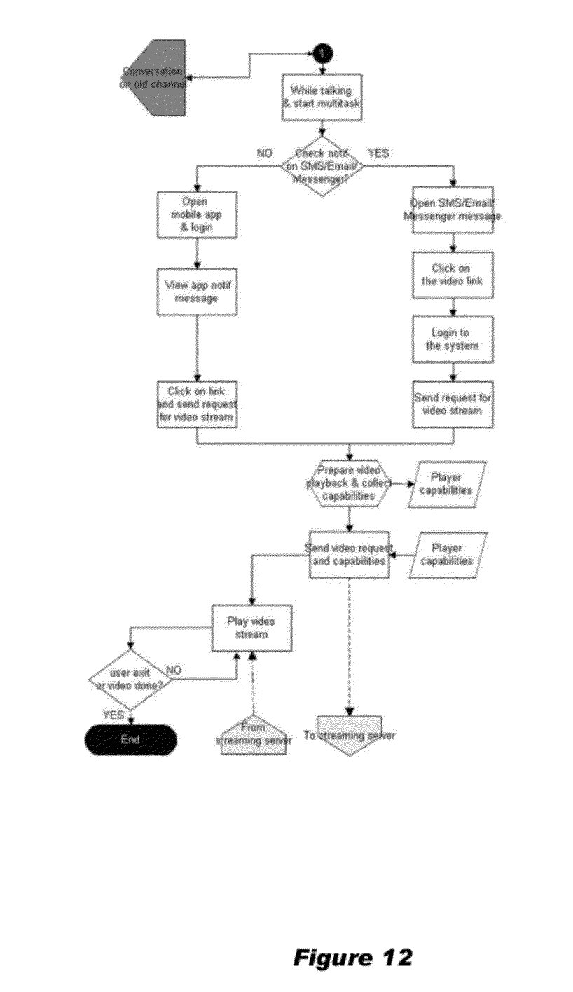

FIG. 12 is a detailed flow diagram for Viewing Client—mobile-phone viewer. Referring to FIG. 12:
The process of receiving video-telephony on a mobile phone starts with the end-user (Viewing Client) or receiver accepting an incoming phone call and notification message via SMS, email or messenger.
The Receiver checks to see if there is any notification and decides if he/she needs to view it or ignore it and open the client application instead.
Any notification will be accompanied with a direct link to the associated video stream.
Upon clicking on the link, the client application is activated. The Receiver is required to login.
Once access is granted, a request for video stream is sent.
If the receiver opts not to open any notification, the client application is activated and the receiver is required to login.
Notification is also delivered via the client application.
When the notification is viewed, the receiver can click on the associated video and the request for video stream is prepared.
The client application redirects the video request and sends playback capabilities to the Streaming Server.
The Identifier component in the Streaming Server determines the player capabilities and transmits the video stream in format playable on the receiver mobile phone.
Upon receiving incoming video stream, the player is activated and the video is played-back.
The playing of the incoming video stream continues until the stream terminates or the receiver exits. At this point the process ends.

(ii) 3.3.2. PC Client

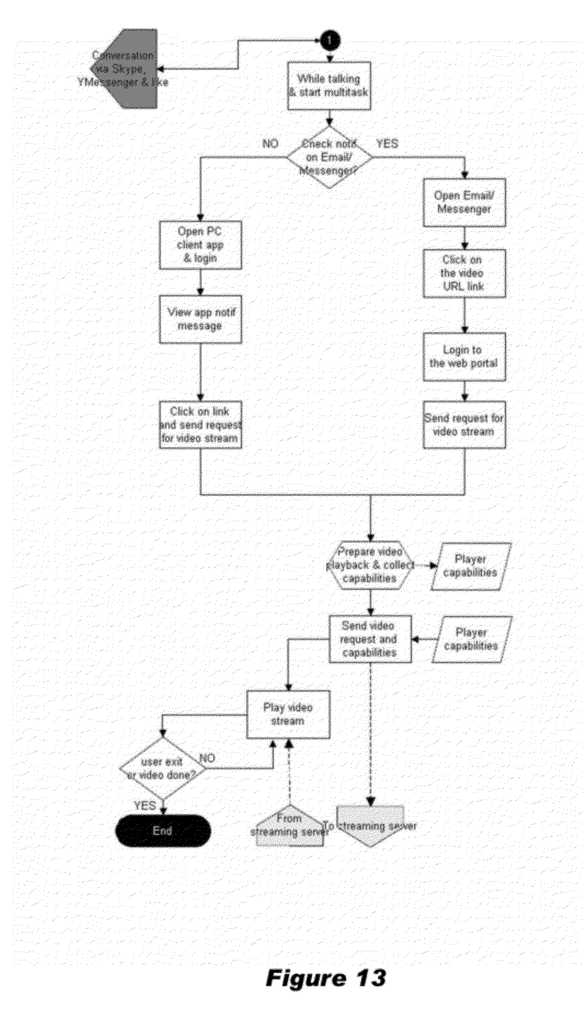

FIG. 13 is a detailed flow diagram for a Viewing Client—PC receiver. The detail process for receiving video-telephony on a PC client is very much similar to the process for receiving it on a mobile-phone client, described herein. Differences include:
The audio conversation would be typically conducted via PC-based VoIP phone app, such as Skype, YahooMessenger and the like.
There is no SMS notification for the PC client.
Instead of a built-in interface for browsing/searching and selecting videos within the mobile phone client, the PC client uses a web-browser to do so.

4. Content Sharing

The Content sharing application allows end users to share views of any running application on a mobile phone or PC with others. It takes sets of consecutive snapshots of the active view and streams it as video. Such capabilities can be embedded within and extend the features of Social Networking and Video Telephony applications. In addition to broadcasting captured live video to others, end users can also broadcast views of running applications to Social Networking sites. While conducting video telephony, end users can stream views of running applications.

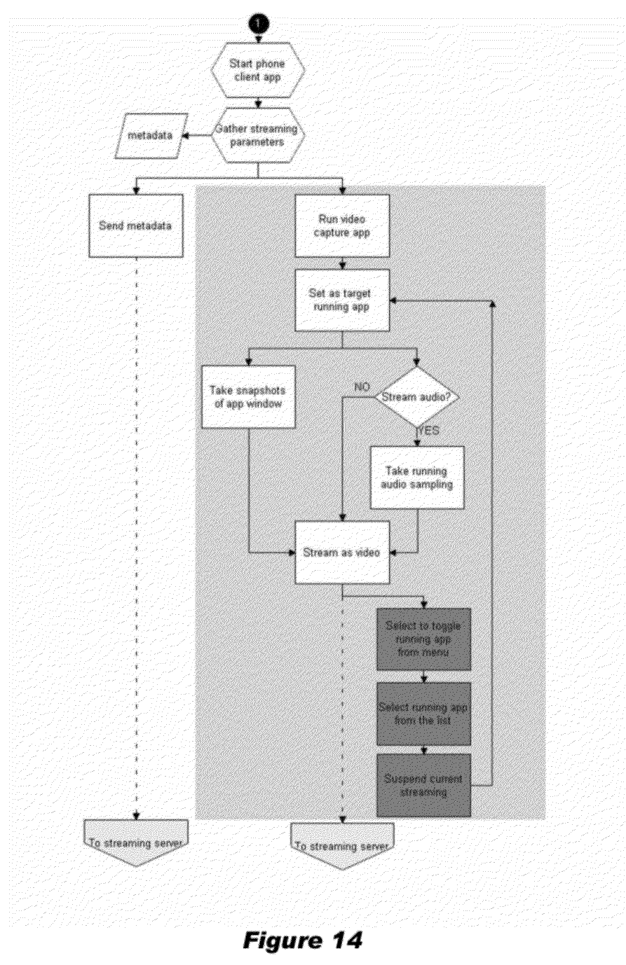

The workflow for the content sharing application is similar to those of the social networking and video telephony, with the differences being in the Streaming Client side. Portions of the workflow for the Streaming Client side is provided with reference to FIG. 14.

The Content sharing application allows end users to share views of any running applications remotely with others, such as presentation windows, document windows, movie playing views and others. End users can simply toggle the active application windows to share different application views in a single session. The technology to achieve this is the same as in the social networking and video-telephony applications, with the addition of application windows toggling capability. Detail of the approach is provided herein.

Much of the flow for the content sharing application is very much similar to the social networking and video-telephony application. At the receiving device, there will be no difference since it is all received as a single video stream. At the streaming side of the video-telephony caller, the only addition is the sub-flow for toggling among different application windows.

The flow for the streaming client or caller is as follows, making reference to FIG. 13:
Start the streaming process for social networking or video-telephony application.
Once the device streams, the end-user or caller clicks on the running applications on the phone menu and views a list of currently running applications on the mobile phone. For PC devices, the end-user can simply select any of the running windows on the desktop as the active view.
Once an application is selected, the system suspends taking snapshots of the current application (i.e., camera application view) and starts taking snapshots of the selected application.
The snapshots are streamed along with any audio to continue the ongoing stream. No streaming session needs to be stopped nor a new one need be created.

### Video-Telephony.

For viewing an incoming video stream, the invention does not rely on any specific hardware or OS/software to be installed on the viewing devices, as in other approaches. As described herein, the transcoder component of the streaming server 2 delivers video in a format playable on the viewing device. However, to stream live video, a cell phone requires client software according to the invention to be installed on the phone. For each different device type and/or OS, a different implementation of the client software of the invention may be used.

The invention leverages traditional audio telephony to transmit audio over a service provider network. It streams only images within the video over the best available network connection. Transmitting audio over traditional telephony provides the traditional high quality audio. Removing audio from the video and streaming the video over a separate network connection allows for higher resolution video and reduced network traffic load. With the widespread practice of paying flat-rate for unlimited WiFi or 3G usage, this approach to video-telephony can reduce cost to the customers.

The invention allows for any participating devices to stream live video capture and view incoming video stream at the same time, providing bi-directional flow.

### 2. Continuous User Experience.

The invention allows the view of any running applications to be captured, shared and streamed as video. For an end-user to continue viewing content on a different viewing device, he/she can easily share and stream view of the application window to the new device, without having to re-register and re-load the same content to the new device.

The same approach described herein regarding sharing and streaming views of application windows is also applicable to local multimedia content. With the invention, it is not necessary to copy and re-load the same local content on different viewing devices.

With the identifier and transcoder capabilities of the invention, there is no longer a requirement for specific hardware or software on the viewing devices to view any video stream.

### Video-Telephony Technologies

While video-telephony has been widely used within the webcam and instant messaging communities, such as Skype, Live Messenger and Yahoo Messenger, there are only a few solutions for cell phones. Following is the list of cell phone solutions known to the applicant: Global IP Solutions VoiceEngine, Canada Rogers, AT&T VideoShare, and VidRunner. Each allow a cell phone user to stream live video captures to other cell phone users while having audio communication. These solutions require specific hardware and software on both the initiating and receiving cell phones. Global IP Solutions requires both phones running Windows Mobile OS, powered specifically by Marvell chipset and Intel processor for optimization purposes. Only a handful cell phones are supported, including HP iPAQ series, Samsung SGH i780 and Gsmart MS808. Canada Rogers supports only HSDPA-ready Samsung A706. VidRunner, on the other hand, supports only Nokia N95. AT&T VideoShare and VidRunner require proprietary software installed on both the initiating and receiving cell phones. Both Canada Rogers and AT&T restrict the video-telephony to run only on their network. As a result of the service providers' limited network bandwidth (such as 2G and 3G), often video quality is low and the cost to customers is high. These technologies capture and stream a set of images and audio as a single video stream on the same network channel. Moreover, live video capture is often streamed in one direction only thus, restricting the receiving party to only having the ability to view, but not stream, the video, i.e., there is no full-duplex capability.

In contrast, the claimed invention requires that only the cell phone (in the case of a cell phone system) that streams the video to be configured with software that directs it to perform the invention with no specific software requirement for the receiving phone. The claimed invention automatically identifies the characteristics (such as hardware, OS, version and media player) of the receiving phone and accordingly transcodes the live video stream into media formats playable on the receiving phone. As noted herein, when transmitting live video, the invention separates the audio from the images. It leverages traditional audio telephony to transmit the audio and streams only images within the video. The audio portion of the video-telephony has the same quality as traditional telephony, and the image-telephony quality is dependent on the available connection speed. Since the invention uses the best connection speed available, it is possible to have the audio telephony run on the provider's 2G/3G network while the video-telephony runs on a faster WiFi connection. Not having to stream audio along with the images allows higher resolution video and reduces network traffic load.

The invention also enables bi-directional video-telephony. Both parties can transmit video and view incoming video streams at the same time.

### Online Conference and Content Distribution Technologies

Another prior art technology is online multimedia content distribution, where a central system streams pre-prepared content to remote end-users. Examples are paid-movie distribution systems such as Netflix and Blockbuster online. Remote end-users can watch movies streamed from a central repository on their desktop PCs. Such a system keeps track of on-going user viewing state. When end-user moves to a different viewing device, it starts from where he/she left off as long as the same type of viewing device is used. However, with this system, multiple viewing devices accessing the same content via the same account at the same time renders such a continuous experience feature inoperable Further, every time an end user uses a new viewing device, he/she is required to register the new device with the central system and again load the same content.

Another prior art technology is online conferencing, where multiple attendees join an online conference and interact remotely via their viewing devices. Examples are online WebEx, LiveMeeting and GoToMeeting. Such systems allow any attendees to share with the group a view of their desktop or running applications. Because of its meeting and presentation nature, sharing high resolution and synchronized content, like movies, is not well supported resulting in noticeably poor video quality. Switching viewing devices also requires attendees to register the new viewing devices to the central system.

For mobile end users with access to multiple viewing devices, the process of re-registering new devices and reloading the same content is cumbersome and time-consuming. In contrast, the invention allows end users to continue viewing multimedia content on different devices without the need for re-registering or reloading. They need only to perform simple point-and-click operations to start sharing and streaming their desktop, or any running application, with others in real-time and in high resolution. Instead of re-loading the same content from the central system, the invention captures what end users are viewing and streams it to the new viewing device. The central system of the invention redirects and broadcasts the streams. An end user can view a running application on a PC desktop from a cell phone and vice-versa. With respect to cell phones, sharing views of the cell phone screen in real time has not been widely supported by existing technologies.

Further, as mentioned herein, the invention identifies the characteristics of an end user's viewing devices and consequently transcodes video stream into a format playable on their viewing devices. Currently Netflix requires Flash player pre-installed to view its online movies and Blockbuster requires Internet Explorer browser and Flash player. To Applicant's knowledge, neither offer movie viewing (streaming) on cell phones. WebEx, LiveMeeting and GoToMeeting require attendees to install proprietary software before they can view content shared by others. In contrast, the invention converts any incoming video stream into playable format on the viewing devices. There is no need for any proprietary software to be downloaded on the viewing device.

### Broadcasting Technologies

Another prior art technology is referred to as a “broadcasting system”, where end users use a video camera to capture a live event and stream it to one or more remote viewers. Broadcasting systems include large broadcasting systems for major live events, PCs with webcameras, and camera-equipped cell phones. Large broadcasting systems are usually equipped with expensive video cameras, capable of capturing and streaming high resolution video. The video is streamed to a specific central broadcasting system for mass distribution. A webcam or camera-equipped phone, connected to the Internet, captures live video and streams it to specific websites for others to view. Camera-equipped phones have been used in video-based social networking systems. Currently anyone wanting to view the video stream in this environment needs to visit the social networking sites and request to view the desired stream. Examples of such systems include Flexwagon, Qik, UstreamTV and Kyte.

Such broadcasting systems capture and stream live video directly from the camera device itself. In contrast, our approach captures and streams what is currently being displayed on the end user's desktop or screen. To stream live video, the end user needs only to have the camera application running on the screen. It treats video playback as any other application running on end user's screen. This generic approach allows for sharing and broadcasting beyond live video capture, extending the capability to other applications such as movie players, document viewers, and even the desktop itself. With the invention a mobile end user can share a document or presentation being displayed on his/her cell phone with others, which sharing is not supported by prior art broadcasting technologies.

While broadcasting systems require the viewers to visit a predefined site for viewing video streams, the invention allows video streams to be pushed directly to viewers' devices via its push notification mechanism. There is no need for viewers to visit any site at all. The notification mechanism of the invention alerts viewers of incoming video streams. Instead of dumping any video stream to a site for viewers to later access, end users can target a video stream for viewing by specific viewers and their devices.

### Differences Between the Invention and the Prior Art Include:

1) The invention treats live video playback as any other running application on end user screen, thereby allowing for streaming of not only live video capture but also other running applications, such as document view, games, presentation view, movie playback and the desktop itself. Such a capability is not supported by prior art technologies, especially for cell phones.
2) The invention automatically identifies a viewing device's characteristics and delivers a video stream in a format playable on the viewing device, removing the requirements for specific hardware and software on the viewing device.
3) The invention separates the audio from the images/video for video-telephony, thus providing high quality audio, higher video quality and reduced cost to end-users.
4) The invention provides bi-directional video streaming, allowing end users to broadcast video streams and view an incoming stream at the same time.
5) The invention enables a seamless continuous user experience without the need for registering new viewing devices and reloading/copying the same content.
6) While prior art broadcasting technologies require end users to visit a pre-defined site for viewing video streams, the invention actively pushes video streams to end users' viewing devices via a notification mechanism.

5. Examples of Uses of the Invention Include:

### 6.1. Online Conferencing

Scenario: Consider a situation where a group of attendees join an online conference via popular online conferencing products, such as WebEx, MS LiveMeeting, GoToMeeting, etc., using their PCs. Suppose a new attendee would like to join the conference; she would typically have to get an invitation (via email), register into the central conferencing system, announce herself to the rest of the attendees, and only then could she view the content being shared.

Using the invention, instead of having the new attendee receive an invitation and register her name into the system, etc., she could simply ask one of the online attendees to share what she is seeing on her PC to the new attendee (with a simple click of the mouse). The new attendee could then view what is being shared in the conference via her PC/TV/Cellphone, without having to identify herself in the online conferencing system, thereby allowing her to remain anonymous.

Scenario: Consider a situation where an attendee of a running online-conference needs to attend to something else and is therefore unable to continue being in-front-of her PC. Currently, in a limited online conferencing product (such as WebEx, using only the iPhone), the attendee could use an iPhone App to re-register into the same online conference and re-announce herself. She could then continue following the meeting while being somewhere else other than in front of her PC. Upon returning to her PC, she would re-register into the conference. Alternatively, two conference connections with the same user could simultaneously be maintained, but this could be costly, that is, paying two active registrations for one attendee, and confusing to other attendees.

With the invention, instead of re-registering into the same conference system from an iPhone App, the mobile attendee could simply share her desktop view to the cell-phone or other mobile devices (such as an Apple iPad) with a simple mouse-click. Once the attendee returns from her other activities, she could simply stop the sharing and continue attending the conference from her PC.

### Benefits:

Seamless, fast process and no-delay. There is no need for the cumbersome and time-consuming process of sending new meeting invitations, re-registering and re-announcing.
Cost reduction. Depending on the service agreement, online conference systems charge their services by the number of attendees. There is potential cost reduction by having only 2 active attendees, and having the rest of the members join via sharing.
Full privacy. An attendee could join the conference without having to register and announce her presence, allowing for full anonymity.
Continuous experience on heterogeneous devices (PC, TV, cell-phones, iPad, etc.) for mobile and multi-tasking attendee.
Support for all cell-phones that have Internet and browser capability,.

### Potential Revenue:

Enterprises can benefit from this, reducing the cost of their online conferences.
Online conference service providers may also benefit from using this solution to reduce the amount of traffic into their central system. With little modification, they could still identify who joins the conference without any registration.

### 6.2. Broadcasting

Scenario: Consider a situation where a CEO or other member of upper management broadcasts live messages during an all-hands meeting to all employees. Employees wanting to join the broadcast would have to register to watch & listen. Live video recording during the all-hands meeting would be streamed into a central system or data center and forwarded to all registered audiences. The central system would have to support the many audiences. Given such requirements, live broadcasting services are typically provided only to upper management or authorized users.

Now consider that, using the invention, some of the already-registered audience could share their view with other employees, thus reducing the traffic/processing burden on the central system. Audiences could view the broadcast from different devices, such as a cell-phone, iPad, TV, PC, etc.

### Benefits:

Reducing the processing & network-traffic load of a central broadcasting system and reducing risk of single point of failure.
Anyone may originate live broadcast without having to put much load onto the central system. For example, a product manager could broadcast a live event to a small team of developers. Anyone with a video cell-phone could take live video capture and broadcast it to others in real time.
Support for many different devices (PC, TV, cell-phones, etc.) to view a live broadcast.

### Potential Revenue:

The software could be licensed to enterprises to reduce the burden on and cost to their central broadcasting system.
The software could also be licensed to service providers, which in turn would sell the service to enterprises.

### 6.3. Journalism

Scenario: The term “citizen journalism”, where a regular citizen with a video-camera or video-ready cell-phone captures live events (such as the 2009 Iran vote protests and the 2010 earthquake in Haiti) and then sends the video to news channels, has been popular the last few years. The video does not provide “real”-time capture of event, since it has to be stored as a file first (in the camera or phones) and later sent to news channels. In many cases, the video files have to be moved to a PC (from video camera or cell-phones) prior to being sent.

Now consider that with the invention, a citizen with a video-ready cell-phone can capture a live event while at the same time transmitting the recording to news channels in real time, without having to save the finished recording, move it to a PC, etc. Moreover, while capturing live-video and broadcasting it at the same time, the citizen can speak on the cell-phone with the news media staff. It is interactive. News media staff/anchors can even direct the citizen as to where to point his/her video-ready cell-phone.

Anyone with a video-ready phone can capture any live event (such as a birthday party or birth of a new baby) and broadcast the event in real-time to specific remote PCs or other phone users (such as family members).

### Benefits:

Anyone with a video-ready cell-phone can be a real-time citizen journalist, providing news media channels with a real-time view of ongoing events
News media can get a real-time view of an ongoing event without the need to have a news crew on site
Anyone with a video-ready cell-phone can share their life experiences with remote loved ones in real-time

### Potential Revenue:

The software can be provided free of charge to cell-phone users and license the software that receives video stream to the news channels
The software can be licensed to service providers to enable them to have the video capture/streaming software of the invention installed on user cell-phones

### 6.4. Help and Support

Scenario: Consider a situation where a network technician while attempting to fix a hardware or connection problem in a data center needs help from a vendor to solve the problem. The technician would probably call the vendor support hotline and describe what she sees (such as network cables, their colors, hardware connected to them, etc.) in words via his cell-phone. The description provided by the technician must be accurate for the vendor staff to help and correct the problem.

Using the invention, the technician can capture what she sees using her video-ready phone and broadcast to the vendor support group, in real time, while also talking via the phone. The vendor support group can view on their PC what the technician sees. The vendor can even direct the technician where she should point her video-ready phone in order to provide more information.

Scenario: Imagine a home user needs technical help from support personnel or a knowledgeable friend who is on the move. The home user would try to describe the best she could what she sees on the PC screen, such as running applications, problems, error messages, etc. The support personnel would try her best to understand the problem and provide instructions to the home user and then request for the home user to describe again what has changed. This process could be error-prone and frustrating.

Using the invention, instead of trying to describe what they see on the PC screen, the home user with a simple mouse-click can broadcast the PC screen to the support personnel's cell-phone. Then the support personnel can more-precisely instruct the home user what to do.

### Benefits:

Providing faster and more accurate support services to customers, thus lowering error and cost
Providing support while in transit
Higher customer satisfaction

### Potential Revenue:

License to enterprise data center support
License to customer support organization

### 6.5. Safety and Security

Scenario: Imagine a child carrying a cell-phone is lost in a large crowded mall or camping area. The child would typically call their parents over the phone and describe her location in words, which may not be accurate given the stressful situation.

With the invention, the child can simply utilize the video capture on the cell-phone and broadcast to the parent, while also talking on the phone. The parent or authority could view what the child sees, identify the child's exact location, and provide the child directions to a safe location.

Scenario: Imagine someone is stranded (or got into an auto accident) in a remote location. With the invention she could simply run video capture using a cell-phone and broadcast it live to an authority's PC, allowing the authority to identify any landmarks and thereby identify the stranded person's exact location.

Since most new cell phones have gps capability, it makes sense that the authority could be provided access to the gps coordinates. . . . There are already cell phone companies that allow users to turn on/off their gps signal . . . so that people who you decide to share location information with you can identify where you are when you are broadcasting your signal. In addition if you have enough signal to broadcast video you are clearly in an area with good cell reception; therefore triangulating your location from cell phone tower should be no problem . . . and clearly much more accurate and rapid than broadcasting video from a cell phone to try to identify one's location.

Scenario: Imagine giving someone directions to a specific store in a large crowded mall or having to purchase the items on a long shopping list. Broadcasting live what the user sees, using the invention, to the remote helper would make it much easier and faster to complete the task (instead of the user describing everything they see in a grocery aisle in words).

### Benefits:

Providing an added level of safety and security in times of need
Better and faster identification of location

### Potential Revenue:

License to service provider as part of their product and service offerings

### 6.6. Home Entertainment

Scenario: Imagine a home with multiple entertainment devices, such as TVs, PCs, cell-phones, game consoles, etc. and the residents would like to subscribe to a pay-per-view service (such as Netflix movie) and play the films on all the devices at the same time. The service provider would have to stream the movie to all the requesting devices.

Using the invention, the service provider needs only to stream the movie to a single PC in the home, and the PC can share the movie with the other devices in the home. Thus the streaming load at the central service provider system can be minimized and the broadcasting tasks are transferred to the home network (probably with better speed and delivery).

### Benefits:

Reduced cost and traffic load at the service provider system
Leveraging the likely utilized home network
Faster delivery and better user experience. It is within home network

### Potential Revenue:

License to service providers

### 6.7. Continuous User Experience

Scenario: Imagine you were watching a movie on your PC, but you have to be mobile and wouldn't want to miss your favorite movie.

With the invention, with a single mouse click, the movie can be broadcast to your cell-phone and you can continue watching while in transit. And when you reach your destination (say your office), you could then continue watching on your office PC starting from where you left off.

Scenario: Imagine you were watching your favorite movie on your PC (say it was provided by Hulu.com) and would like to share the same experience with your friends and discuss it over the phone or messaging services. Your friends would have to go to the same Hulu movie site and search for the same movie title. Once played, the same movie your friends were watching may not be synchronized with the one you were watching.

With the invention, instead of your friends going to the Hulu.com site and searching for the same movie title, you can simply broadcast your PC screen live to your friends' movie-playing devices (e.g., PC, cell-phone, iPad, game console, etc.). Your friends' movie-watching experience will then be synchronized with yours, allowing for a shared experience among friends regardless of location/physical proximity.

### Benefits:

Continuous user experience on different devices (i.e, PC, cell-phone, TV, game console, etc.)
Synchronized experience, i.e., continue watching where you leave off or allow multiple audiences to synchronously watch the same movie
Reduced traffic load at the central service provider system

### Potential Revenue:

License the application to service providers
Providing the software to end users free-of-charge with some paid-ads

### 6.8. Sharing Through a Social Networking Community

Scenario: Imagine that while on vacation you saw a magnificent view and would like to share this picturesque sight with your friends on popular social networking sites (like Facebook, MySpace, etc.). Currently, you would have to take a video snapshot of the view, save it into a video file, and upload the file to your social networking site for your friends to view. However, this does not allow friends to simultaneously share the experience with you. While your text chat/comment on your social networking page is essentially “real-time”, your video capture is not.

Using the invention, instead of developing a video file that is later uploaded onto your social networking page, you can take video captures using your cell-phone and stream them live onto your social networking page. It is essentially in real-time; your friends can see the magnificent view at essentially the same moment that you view it, allowing you and your friends' chats and comments on social networking pages to be more relevant and interactive.

### Benefits:

Real-time video sharing of one's life experiences on the social networking site
More interactive, relevant, and real-time discussion of video content
Increased usage, traffic and discussion on the social networking site

### Potential Revenue:

From ads, shared with social networking site operators
License to social networking site operators

Next described are detailed descriptions of the data flows within the approach and function of the invention. The following depicts the overall architecture. It consists of 4 main layers, streaming client, streaming server, viewing client and application layers.

Areas of novelty include the approach of treating live video playback as any other running application on end user screens, allows for streaming of not only live video capture but also other running applications, such as document view, games, presentation view, movie playback and the desktop itself. Such a capability is not supported by existing technologies, especially for cell phones.

The herein-described steps can be implemented using standard well-known programming techniques. The novelty of the herein-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A system for digitally streaming content, comprising:
a streaming client;
a viewing client; and
a streaming server coupled between said streaming client and said viewing client, said streaming server being configured to:
process streaming requests from said viewing client;
identify streaming parameters of said viewing client;
receive streaming content from said streaming client;
convert said received streaming content to a format consistent with the streaming parameters of said viewing client; and
provide said converted received streaming content to said viewing client.
